(19) United States
(12) Patent Application Publication
(10) Pub. No.: US 2025/0284969 A1
(43) Pub. Date: Sep. 11, 2025

(54) SYSTEMS AND METHODS FOR STABILIZATION OF MULTI-AGENT REINFORCEMENT LEARNING

(71) Applicant: Samsung Display Co., Ltd., Yongin-si (KR)

(72) Inventors: Shuhui Qu, Fremont, CA (US); Janghwan Lee, Pleasanton, CA (US)

(21) Appl. No.: 18/653,901

(22) Filed: May 2, 2024

Related U.S. Application Data
(60) Provisional application No. 63/563,161, filed on Mar. 8, 2024.

(51) Int. Cl. G06N 3/092

(52) U.S. Cl. CPC G06N 3/092

(57) ABSTRACT

A manufacturing system may include a processor and a memory storing instructions executed by the processor to cause the processor to identify one or more converging agents from a first group of agents, in response to the identification of the one or more converging agents, perform training of one or more non-converging agents of the first group of agents using historic data to form a second group of agents, identify one or more converging agents from the second group of agents, in response to the identification of the one or more converging agents from the second group of agents, update policy of the one or more non-converging agents of the second group of agents based on historic data collected by heuristic rule-based policy to form a third group of agents, and deploy, a policy based on the first, second, and third group of agents.

### CROSS-REFERENCE TO RELATED APPLICATION(S)

This application claims the priority benefit under 35 U.S.C. § 119 (e) of U.S. Provisional Application No. 63/563,161, filed on Mar. 8, 2024, the disclosure of which is incorporated by reference in its entirety as if fully set forth herein.

### FIELD

The present disclosure generally relates to improving manufacturing processes. More particularly, the subject matter disclosed herein related to improvements to systems and methods for stabilization of multi-agent reinforcement learning.

### SUMMARY

Manufacturing facilities, such as for example, electronic device manufacturing facilities or semiconductor fabrication facilities, often have hundreds of machines in operation, producing hundreds of thousands of diverse products in order to meet production goals and customer demands. Different products may require using multiple machines across the facilities in various orders. Thus, many machines are not only used to produce one product but often used to produce multiple products. Additionally, some products are treated with a higher priority for a faster production, for example, because certain customers may have paid for expedited delivery, or because some products may be in higher demand due to product shortages and/or seasonal demands, etc. Thus, efficient coordination in the operation and utilization of these machines is desired to increase productivity and maximize utilization. Some techniques for facilities operations include utilizing an experienced human (e.g., a manufacturing supervisor or manager) to oversee and coordinate the operation of the machines. However, such human-based scheduling approach relies on the expertise of the person, which can take many years of training to generate reasonable schedules. Furthermore, as the size of the manufacturing facilities grow and produce hundreds of thousands of products across hundreds of different machines, it can become difficult even for the most experienced person to coordinate. Computer automation such as reinforcement Learning (RL)-based scheduling techniques have introduced significant potentials in the realm of scheduling improved techniques. As the complexity of production increases, multiple RL-based scheduling techniques may be utilized through multi-agent RL (MARL) based schedulers. However, appropriate coordination between the MARL is desired to achieve convergence of the agents in the MARL system to maintain stability and also achieve optimal performance.

In some embodiments, a manufacturing system may include: a processor; and a memory storing instructions executed by the processor to cause the processor to: identify one or more converging agents from a first group of agents; in response to the identification of the one or more converging agents, perform training of one or more non-converging agents of the first group of agents using historic data to form a second group of agents; identify one or more converging agents from the second group of agents; in response to the identification of the one or more converging agents from the second group of agents, update policy of the one or more non-converging agents of the second group of agents based on historic data collected by heuristic rule-based policy to form a third group of agents; and deploy, a policy based on the first group of agents, the second group of agents, and the third group of agents.

The training of the one or more non-converging agents of the first group of agents may include performing reinforcement learning training.

The training may be performed offline and the historic data is collected from a multi-agent environment.

The training may include determining a least-squared temporal difference.

The instructions may further cause the processor to freeze neural network weights of the identified one or more converging agents from the first group of agents and the second group of agents.

The heuristic rule-based policy may correspond to a known reward function.

The updating the policy of the one or more non-converging agents of the second group of agents may include setting a least-squared temporal difference between the policy and the heuristic rule.

The instructions may further cause the processor to: identify one or more converging agents from the third group of agents; in response to the identification of the one or more converging agents from the third group of agents, assigning a heuristic policy to one or more non-converging agents from the third group of agents; and combine the converging agents from the first group of agents, the second group of agents, and the third group of agents, with the assigned heuristic policy.

In some embodiments, a method may include: identifying, by a processor, one or more converging agents from a first group of agents; in response to the identification of the one or more converging agents, performing, by the processor, training of one or more non-converging agents of the first group of agents using historic data to form a second group of agents; identifying, by the processor, one or more converging agents from the second group of agents; in response to the identification of the one or more converging agents from the second group of agents, updating, by the processor, policy of the one or more non-converging agents of the second group of agents based on historic data collected by heuristic rule-based policy to form a third group of agents; and
deploying, by the processor, a policy based on the first group of agents, the second group of agents, and the third group of agents.

The training of the one or more non-converging agents of the first group of agents may include performing reinforcement learning training.

The training may be performed offline and the historic data is collected from a multi-agent environment.

The training may include determining a least-squared temporal difference.

The method may further include freezing neural network weights of the identified one or more converging agents from the first group of agents and the second group of agents.

The heuristic rule-based policy may correspond to a known reward function.

The updating the policy of the one or more non-converging agents of the second group of agents may include setting a least-squared temporal difference between the policy and the heuristic rule.

The method may further include: identifying, by the processor, one or more converging agents from the third group of agents; in response to the identification of the one or more converging agents from the third group of agents, assigning, by the processor, a heuristic policy to one or more non-converging agents from the third group of agents; and combining, by the processor, the converging agents from the first group of agents, the second group of agents, and the third group of agents, with the assigned heuristic policy.

In some embodiments, a computer-readable medium may store instructions that, when executed by one or more processors, cause the one or more processors to perform a method including: identifying, by a processor, one or more converging agents from a first group of agents; in response to the identification of the one or more converging agents, performing, by a processor, training of one or more non-converging agents of the first group of agents using historic data to form a second group of agents; identifying, by a processor, one or more converging agents from the second group of agents; in response to the identification of the one or more converging agents from the second group of agents, updating, by a processor, policy of the one or more non-converging agents of the second group of agents based on historic data collected by heuristic rule-based policy to form a third group of agents; deploying a policy based on the first group of agents, the second group of agents, and the third group of agents.

The training of the one or more non-converging agents of the first group of agents may include performing reinforcement learning training, and the training may be performed offline and the historic data is collected from a multi-agent environment.

The one or more processors may perform a method including freezing neural network weights of the identified one or more converging agents from the first group of agents and the second group of agents.

The one or more processors may perform a method including: identifying one or more converging agents from the third group of agents; in response to the identification of the one or more converging agents from the third group of agents, assigning a heuristic policy to one or more non-converging agents from the third group of agents; and combining, by the processor, the converging agents from the first group of agents, the second group of agents, and the third group of agents, with the assigned heuristic policy.

### BRIEF DESCRIPTION OF THE DRAWINGS

In the following section, the aspects of the subject matter disclosed herein will be described with reference to exemplary embodiments illustrated in the figures, in which:

FIG. 1 depicts an example block diagram of a manufacturing facility, according to one or more embodiments of the present disclosure.

FIG. 2 illustrates a reinforcement learning system in training, according to one or more embodiments of the present disclosure.

FIG. 3 illustrates a multi-agent reinforcement learning (MARL) system in training, according to one or more embodiments of the present disclosure.

FIGS. 4A-4C illustrate various configurations in which the different agents of the MARL system may be configured, according to one or more embodiments of the present disclosure.

FIG. 5 is a flowchart of a method for executing training of the reinforcement agents in the MARL system, according to one or more embodiments of the present disclosure.

FIG. 6 is a flowchart of a method of executing a schedule, according to one or more embodiments of the present disclosure.

FIG. 7 is a block diagram of an electronic device in a network environment, according to one or more embodiments of the present disclosure.

### DETAILED DESCRIPTION

In the following detailed description, numerous specific details are set forth in order to provide a thorough understanding of the disclosure. It will be understood, however, by those skilled in the art that the disclosed aspects may be practiced without these specific details. In other instances, well-known methods, procedures, components and circuits have not been described in detail to not obscure the subject matter disclosed herein.

Reference throughout this specification to “one embodiment” or “an embodiment” means that a particular feature, structure, or characteristic described in connection with the embodiment may be included in at least one embodiment disclosed herein. Thus, the appearances of the phrases “in one embodiment” or “in an embodiment” or “according to one embodiment” (or other phrases having similar import) in various places throughout this specification may not necessarily all be referring to the same embodiment. Furthermore, the particular features, structures or characteristics may be combined in any suitable manner in one or more embodiments. In this regard, as used herein, the word “exemplary” means “serving as an example, instance, or illustration.” Any embodiment described herein as “exemplary” is not to be construed as necessarily preferred or advantageous over other embodiments. Additionally, the particular features, structures, or characteristics may be combined in any suitable manner in one or more embodiments. Also, depending on the context of discussion herein, a singular term may include the corresponding plural forms and a plural term may include the corresponding singular form. Similarly, a hyphenated term (e.g., “two-dimensional,” “pre-determined,” “pixel-specific,” etc.) may be occasionally interchangeably used with a corresponding non-hyphenated version (e.g., “two dimensional,” “predetermined,” “pixel specific,” etc.), and a capitalized entry (e.g., “Counter Clock,” “Row Select,” “PIXOUT,” etc.) may be interchangeably used with a corresponding non-capitalized version (e.g., “counter clock,” “row select,” “pixout,” etc.). Such occasional interchangeable uses shall not be considered inconsistent with each other.

Also, depending on the context of discussion herein, a singular term may include the corresponding plural forms and a plural term may include the corresponding singular form. It is further noted that various figures (including component diagrams) shown and discussed herein are for illustrative purpose only, and are not drawn to scale. For example, the dimensions of some of the elements may be exaggerated relative to other elements for clarity. Further, if considered appropriate, reference numerals have been repeated among the figures to indicate corresponding and/or analogous elements.

The terminology used herein is for the purpose of describing some example embodiments only and is not intended to be limiting of the claimed subject matter. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It will be understood that when an element or layer is referred to as being on, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the term “and/or” includes any and all combinations of one or more of the associated listed items.

The terms “first,” “second,” etc., as used herein, are used as labels for nouns that they precede, and do not imply any type of ordering (e.g., spatial, temporal, logical, etc.) unless explicitly defined as such. Furthermore, the same reference numerals may be used across two or more figures to refer to parts, components, blocks, circuits, units, or modules having the same or similar functionality. Such usage is, however, for simplicity of illustration and ease of discussion only; it does not imply that the construction or architectural details of such components or units are the same across all embodiments or such commonly-referenced parts/modules are the only way to implement some of the example embodiments disclosed herein.

Unless otherwise defined, all terms (including technical and scientific terms) used herein have the same meaning as commonly understood by one of ordinary skill in the art to which this subject matter belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As used herein, the term “module” refers to any combination of software, firmware and/or hardware configured to provide the functionality described herein in connection with a module. For example, software may be embodied as a software package, code and/or instruction set or instructions, and the term “hardware,” as used in any implementation described herein, may include, for example, singly or in any combination, an assembly, hardwired circuitry, programmable circuitry, state machine circuitry, and/or firmware that stores instructions executed by programmable circuitry. The modules may, collectively or individually, be embodied as circuitry that forms part of a larger system, for example, but not limited to, an integrated circuit (IC), system on-a-chip (SoC), an assembly, and so forth.

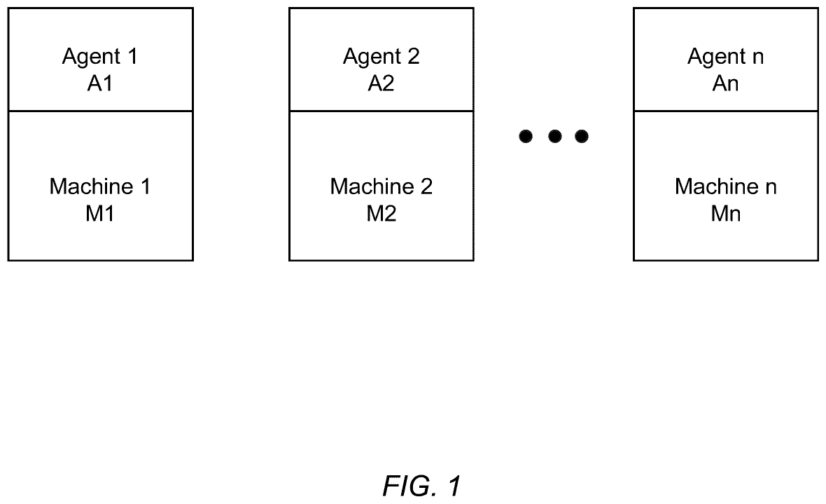

FIG. 1 depicts an example block diagram of a manufacturing facility. Referring to FIG. 1, the example manufacturing facility may have n machines M1, M2, . . . . Mn that may be configured to produce different products. Although the output of the machines may be referred to as “products” in the present disclosure, such “products” may correspond to whole products (e.g., a complete television set), a portion or portions of a product (e.g., a display portion of a television), and/or components of a product (e.g., semiconductor chips). Each of the machines M1, M2, . . . . Mn may be associated with a corresponding agent A1, A2, . . . . An, which may include an RL-based scheduler that controls the operation of the machines according to assigned policies. In some embodiments, the product generated by the machines may be independent of other machines. For example, machine M1 may be configured to generate a transistor for a display device, whereas machine M2 may be configured to generate a case for a cell phone. Thus, the operation of one machine has nothing to do with the operation of the other machine because the products are unrelated to one another. In other embodiments, one machine may rely on the product generated by another machine. For example, machine 1 may be configured to generate a transistor, and machine 2 may be configured to install that transistor on a circuit board of a display device. Thus, machine 2 relies on machine 1 to generate the transistors, which is then installed on the circuit board. Therefore, coordination between machine 1 and machine 2 may be desired or even necessary for efficient operation of the manufacturing process. As can be seen, the operation of the various machinery in a factory may be complex and the scheduling the run-time of the machines may be implemented by generating and deploying policies. Thus, a reinforcement learning system may be implemented throughout the factory to deploy such policies on the machines for efficient operations.

Herein the present disclosure, the term “policy” may be defined as a set of rules, guidance, or instructions, that are to be followed in performing a task. Thus, for example, a policy such as “first come first served” means that the first person (or thing) that comes is the first person (or thing) that is served (or processed). Therefore, in the context of the embodiments of the present disclosure, a policy for a machine in a factory may be a set of rules that govern when the machine is to run and when the machine is to be idle or off, and/or what product the machine is to produce. Yet, in a further example, the policy may be implemented in a module (e.g., a computing module including a neural network) that may take various parameters such as queue length and arrival time, and then generate an output from the computing module an assigned priority for each job that a particular machine is going to perform. Hence, the jobs may be selected to be processed according to the assigned priority. The, the terms “deploy” or “deployment” as used in the present disclosure is intended to mean that a given policy is implemented on a machine or other manufacturing devices, tools, and/or industrial computers on-site, in a facility so that the machine may operate in according with the deployed policy.

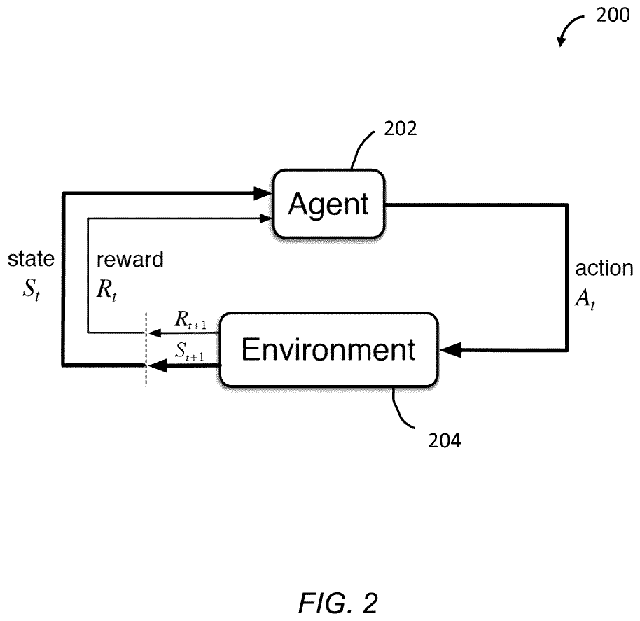

FIG. 2 illustrates a reinforcement learning system in training according to one or more embodiments of the present disclosure. Referring to FIG. 2, a reinforcement learning system 200 may include an agent 202 and an environment 204. During training, as the agent 202 traverses the environment 204, it may generate or learn a set of rules or policies to help it decide which action to take next for an optimal reward. In other words, the policies generated by the agent 202 during training may be defined by a set of environment and agent states(S), a set of actions (A) taken by the agent 202, the probability of transition (P) from a current state(s) to a next state (s′) under an action (a), and an immediate reward (e.g., Ra (s, s′)) after transitioning from the current state(s) to the next state (s′) for taking the action (a).

In more detail, reinforcement learning (RL) is modeled as a Markov decision process (e.g., <S, A, R, P>). For example, at every time step (t), the agent 202 takes an action (Aₜ) in the environment 204 based on a current set of environment and agent states (Sₜ) and a reward (Rₜ) resulting from a previous action (e.g., Aₜ₋₁). A next set of environment and agent states (Sₜ+1) for a next time step (t+1) may be observed resulting from the action (Aₜ), and the resulting reward (e.g., Rₜ₊₁) for transitioning from the current state (Sₜ) to the next state (Sₜ₊₁) may be calculated. As a result of the training, a set of policies may be generated for the resulting RL model based on the reward functions, and during inference, the RL model may be deployed so that the policies may be used to automatically generate the schedules.

For example, when the RL model is optimized for a reward function corresponding to a goal or evaluation metric of serving customers in the order in which they are received, the corresponding policy may be first-in first-out. As another example, when the RL model is optimized for a reward function corresponding to a goal or evaluation metric of serving high priority customers first, the corresponding policy may be to serve a higher priority queue first or a shortest queue first.

However, in a large-scale production line in a complex manufacturing facility, a multi-agent reinforcement learning (MARL) system (e.g., MARL-based photo scheduler) may be implemented. In other words, the system may employ multiple RL agents, as those described above with reference to FIG. 2, to optimize complex scheduling tasks. One aspect of a MARL system is its sensitivity to data distribution, which impacts convergence. Thus, the effectiveness of a MARL-based scheduler may hinge on the quality and distribution of data. Additionally, in non-stationary environments, the interdependence of agents in MARL systems like the photo scheduler creates a dynamic scenario where traditional stationary assumptions may be inadequate. The complexity resulting from one agent's actions having an influence over other agents poses significant challenges in the training and operational effectiveness of the MARL system. Moreover, some agents in the MARL system may fail to converge consistently during online and offline training, which also has an impact on the overall system performance.

However, incorporating a plurality of RL systems to form a MARL system does not come without its challenges. The stability of each agent may be significantly impacted by the non-stationary nature of the environment in which they operate. In such environments, the distribution of trajectories that an agent observes may be subject to continual change. The steady state, d(s,a), may no longer solely dependent on the agent's own policy or actions. It may also be influenced by the dynamic interplay of multiple agents and the evolving state of the environment. Therefore, this variability introduces a level of unpredictability in the agent's learning process, further complicating the task of achieving stable and effective policy convergence. One concern in a MARL system is the potential for agents to take random actions if they do not achieve convergence. Without converging to a stable policy, agents may fail to learn the optimal actions to maximize their long-term rewards.

Ensuring optimal performance may be contingent on the convergence of all agents in the MARL system. Without convergence, the system may not be able to guarantee its intended efficiency or effectiveness. Establishing trust in the algorithm's deployment relies on every agent to not only converge, but also exhibit behavior that is both normal and comprehensible to humans. This understanding may be crucial for some users to confidently rely on the MARL system. If an agent's policy fails to converge during training, it could lead to unpredictable or random activities during the system's actual deployment, posing risks to operational stability and reliability. Thus, it is desirable to improve performance of a MARL system by stabilizing all agents, and thereby achieving convergence. Stabilization of all agents may be crucial for enhancing overall system performance in complex environments because stability of agents is key for achieving reliable, efficient task execution, and accurate decision-making. Moreover, achieving stability directly impacts the operational success of the MARL system in dynamic scenarios. Accordingly, the stabilization of agents to achieve convergence is fundamental for the functionality and effectiveness of the MARL system, addresses challenges in non-stationary environments and variable data distributions, and convergence across all agents build trust, and ensures predictable and understandable behavior. Therefore, one or more embodiments of the present disclosure may be directed to techniques for ensuring convergence of all or substantially all of the agents in a MARL system to guarantee reliable functionality and effectiveness of the MARL system, and focus on overcoming non-stationary challenges and handling diverse data distributions. Furthermore, one or more embodiments may be directed to achieving relatively higher performance under convergence of all or substantially all of the agents to ensure that stability and convergence of agents lead to higher scheduling performance.

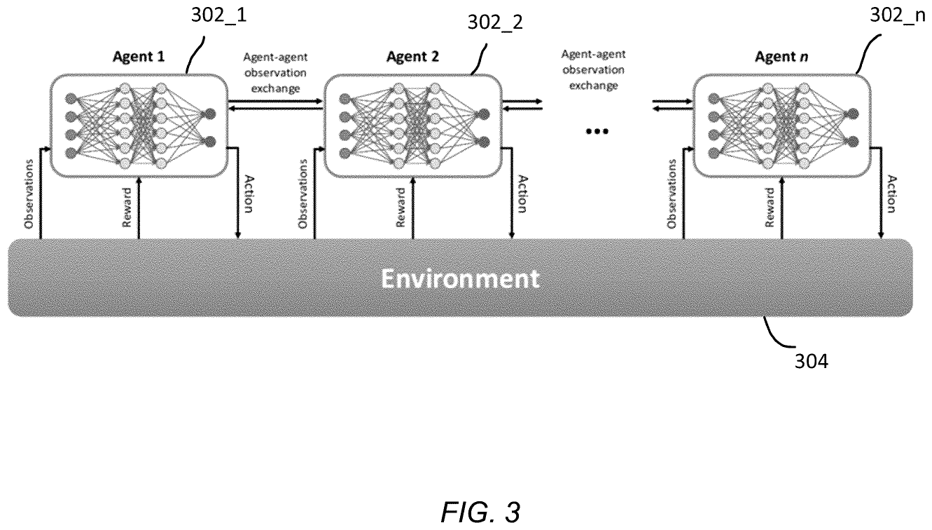

FIG. 3 illustrates a MARL system in training according to one or more embodiments of the present disclosure. Referring to FIG. 3, a MARL system 300 may include a plurality of agents 302_1, 302_2, 302_n, and an environment 304. Here, each agent 302_1, 302_2, 302_n of the MARL system may correspond to the agent in the RL system illustrated and described above with reference to FIG. 2 and will not be repeated here. Differently from the single RL system of FIG. 2, the multiple agents in the MARL system of FIG. 3 operate and influence their environment in a synchronous/asynchronous manner. Each of the agents 302_1, 302_2, 302_n in the MARL system may interact with the shared environment 304 to make decisions that not only affect their immediate circumstances but also have influence on the other agents and the overall system. Accordingly, this training may be facilitated through rewards emitted by the system, which guide the agents toward strategies that not only optimize their individual long-term benefits but also contribute to increasing (e.g., maximization) the global long-term reward.

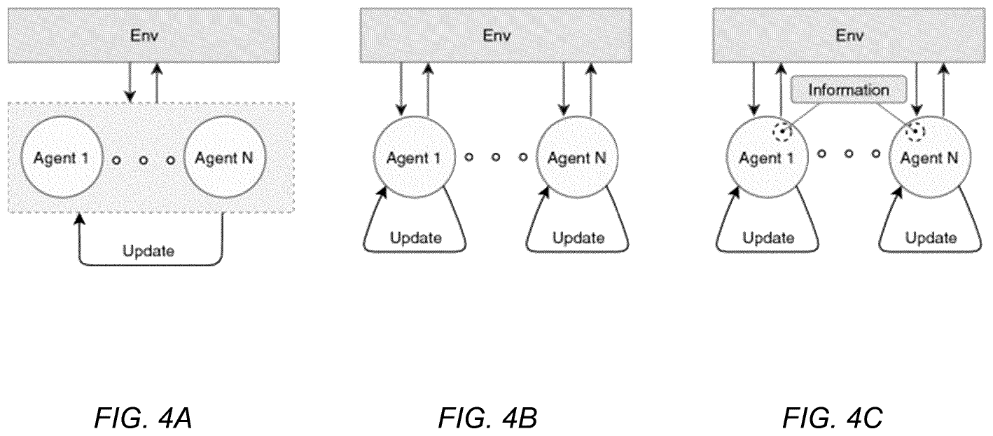

FIGS. 4A-4C illustrate various configurations in which the different agents of the MARL system may be configured. In the MARL system illustrated in FIG. 4A, all of the agents (e.g., agents 1-n) may make decisions together at the same time, then they interact with the environment, and then all of the agents get updates from the environment. In the MARL system illustrated in FIG. 4B (known by those skilled in the art as a Rainbow MARL model), each of the agents (e.g., agent 1-n) work independently and also interact with the environment independently, and then the individual agents get updated at different times from other the agents. In the MARL system illustrated in FIG. 4C, the agents (e.g., agents 1-n) may share information with each other, for example, by telling each other what it has done and the reason why it makes such decisions. However, each agent interacts with the environment independently and they all get updated at different times, like the MARL system illustrated in FIG. 4B. Thus, as illustrated in FIGS. 4A-4C, different configurations of MARL system are possible, and that other configurations not shown here may also be envisaged by those having ordinary skill in the art.

While embodiments of the present disclosure are described in more detail hereinafter in the context of training agents for coordinating various manufacturing processes and the like for the machines M1-Mn, the present disclosure is not limited thereto. For example, the systems and methods described herein may be applicable to any suitable systems and methods that may benefit from generating a new combination of existing policies for a new reward function. In other words, as long as there is a policy that takes in some parameters/factors and outputs a decision/action, it can be combined with another policy according to one or more embodiments of the present disclosure. For example, the systems and methods described in more detail hereinafter may be applicable to various robotic control applications, navigation systems, autonomous driving applications, large language model training, and the like.

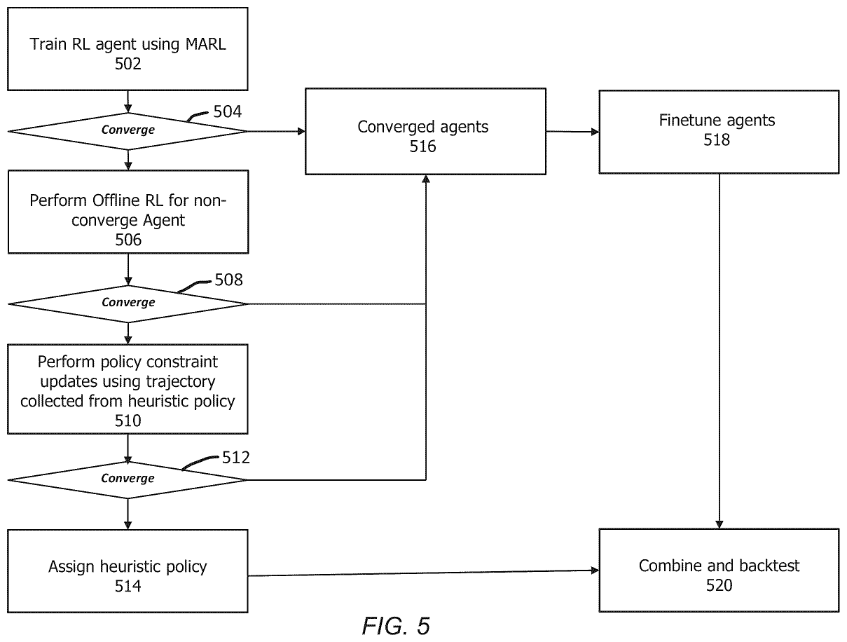

FIG. 5 is a flowchart of a method for executing a training of the RL agents in a MARL system, according to one or more embodiments of the present disclosure. Generally speaking, the described technique performs three processes, and before each process, the converged agents are removed or frozen. In more detail, first, when the MARL training starts (502), any agents that have already converged are removed (504) to the converged agent block (516) where the neural network weights of the converged agents are frozen. Next, offline RL may be performed for the remaining agents that did not converge in an effort to converge these agents (506). Offline RL may also be known as batch RL or data-driven RL by persons having ordinary skill in the art, and refers to an approach where RL algorithms effectively leverage previously collected experience without requiring online interaction. In other words, an online training approach utilizes data collected from real world or actual operations of the RL, hence being an online transaction. However, an offline training approach utilizes historical data or data that was collected from past operations within the multi-agent environment to train the RL. In one embodiment, the offline RL may be performed by utilizing a least-squared temporal difference method, which may be represented by the equation:

min_{Q}E_{(s,a)˜π(s,a)}[(Q(s,a)−y(s,a))²]

where E is the expectation, Q is a function of the current state s and action a, and y is the predicted value of the state s and action a. The predicted value may be represented by the equation:

$$y ( s , a ) = r ( s , a ) + {E}_{{a}^{′} ∼ π} [ Q ( {s}^{′} , {a}^{′} ) ]$$

where r is the reward of the state s′ and action a′, and E is the estimated value of the Q function based on the next state s and next action a. Therefore, the offline data is utilized to minimize the loss function (Q(s,a)−y(s,a)).

π can be π_{θ} or π_{\hat{θ}}=argmax_{π}E_{a˜π}[Q(s,a)]

where π is the policy that can always find the action a to higher Q value given the current state s. It should be noted that the above-described offline RL is just one example, and that a person having ordinary skill in the art may implement other offline RL training methods such as an imitation learning method. Accordingly, any of the agents that converged as a result of the offline RL training are removed (508) to the converged agent block (516).

Next, policy constraint updates may be performed on the remaining agents that did not converge after the offline RL training was performed (510). More in particular, policy constraint updates include also utilizing historical data but instead of directly utilizing the historical data as in the offline RL training, here, heuristic rule-based policies may utilize the historical data. That is, the historical data may be collected using the heuristic rule-based policy (e.g., first come first served policy) based on the reward function that is already known. In some embodiments, the reward function may be designed based on the utilization rate and the priority of jobs. In other words, because the reward function is already known, the policy may be designed based on the reward function. Therefore, for example, if the reward function is to minimize the waiting time of job, then a first come first serve rule may be designed. Then, given the rule-based policy, a simulator may be utilized to roll out a trajectory with both the converged agents with frozen weights and the non-converged agents operating under the newly designed heuristic rule policies as D. In a similar manner to the offline RL training, the following equation may be minimized:

min_{Q}E_{(s,a)˜π}_{_{θ}}_{(s,a)}[(Q(s,a)−y(s,a))²]

$$y ( s , a ) = r ( s , a ) + {E}_{{a}^{′} ∼ {π}_{θ}} [ Q ( {s}^{′} , {a}^{′} ) ]$$

π_{θ}=argmax_{π}E_{s˜D,a˜π}_{_{θ}}[Q(s,a)]

However, the difference between the offline RL training and here is that the difference is constrained between the policy (π_{θ}(a|s)) and the heuristic rule (πₕₑ(a|s)), which may be expressed as: s.t. D(π_{θ}(a|s)∥πₕₑ(a|s))≤ϵ, where D is a distance measure such as Euclidean distance. Therefore, the policy may be as close to the human designed heuristic rule as possible because the human designed rule is understandable and theoretically converges. Next, the converged agents are again removed (512) to the converged agent block (516), where it is combined with all of the previously converged agents in block (516). The group of converged agents may then be fined tuned together at block (518), where weights and policies are assigned to the agents, the trajectory is rolled out, and the agents are optimized with an RL algorithm such as, e.g., the Rainbow algorithm, using data to improve the performance.

In some embodiments, the remaining non-converged agents (i.e., the agents that were not converged from any of the offline RL training or the policy constraint update processes) are assigned a heuristic policy (514). In other words, a human understandable heuristic policy may be force-assigned by a human for all remaining agents that did not converge from all of the previous attempts to converge the agents.

In some embodiments, the heuristic rule policy may be designed or selected based on the stage reward function to ensure that the policy is inherently aligned with achieving higher rewards at each stage of the process. The stage reward function may be a weighted combination of several reward items, and these reward items may include: 1) number of jobs processed, which includes evaluating the efficiency and throughput of the agent by considering the total number of jobs it successfully processes within a given timeframe, 2) priority of the job, which includes integrating a prioritization metric that assesses and values jobs based on their importance or urgency, contributing to a more intelligent and responsive decision-making process, and/or 3) change of mask, which include factors related to operational changes or adaptations, such as mask changes, which are utilized for dynamic and flexible process management. However, the above-described reward items are merely some examples and may instead include many other reward items that may be envisaged by those having ordinary skill in the art. Finally, the agents with the assigned heuristic policy may be combined with the agents that were fine-tuned at block (518), and then tested to validate algorithm effectiveness (520) in preparation for deployment. Accordingly, the plurality of agents in a MARL system may be converged to stabilize the overall agent behavior and achieve high performance by the agents. Furthermore, this training framework optimizes the interaction and coordination among the multiple agents in the system, thereby leading to improved decision-making, efficiency, and reliability in complex operational settings.

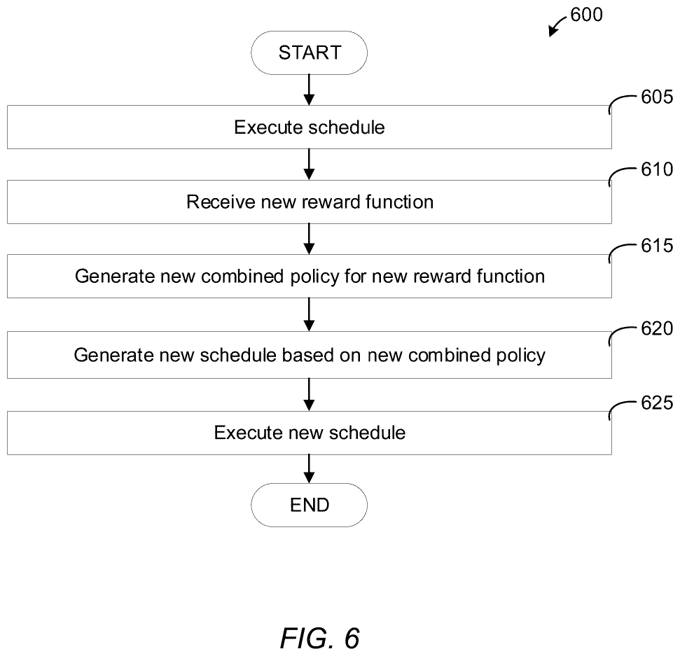

FIG. 6 is a flowchart of a method of executing a schedule according to one or more embodiments of the present disclosure. The method 600 shown in FIG. 6, may be performed, for example, by the agent 302 described above with reference to FIG. 3. However, the present disclosure is not limited thereto, and the operations shown in the method 600 may be performed by any suitable one of the components and elements or any suitable combination of the components and elements of those of one or more example embodiments described above. Further, the present disclosure is not limited to the sequence or number of the operations of the method 600 shown in FIG. 6, and can be altered into any desired sequence or number of operations as recognized by a person having ordinary skill in the art. For example, in some embodiments, the order may vary, or the method 600 may include fewer or additional operations. Further, the operations shown in method 600 may be performed sequentially, or at least some of the operations thereof may be performed concurrently (e.g., simultaneously, or substantially simultaneously).

Referring to FIG. 6, the method 600 may start, and a schedule may be executed at block 605. For example, in some embodiments, the schedule may be executed to coordinate machine actions in a factory, schedule navigation tasks, coordinate language model tasks, and the like. A new reward function may be received at block 610. For example, in some embodiments, a new reward function corresponding to an evaluation criteria for the generated schedules may be received at block 610 (e.g., from a domain expert and the like).

A new combined policy may be generated for the new reward function at block 615. For example, the new combined policy may be generated for the new reward function as a parameterized (e.g., a weighted) combination of a plurality of existing policies based on the new reward function and the performance threshold criteria as discussed above with reference to the methods 400 and 500 of FIGS. 4 and 5. As a result, a new schedule may be generated based on the new combined policy at block 620.

The new schedule may be executed at block 625, and the method 600 may end. For example, executing the new schedule at block 625 may include changing the order of machine operations, selecting different navigation tasks, changing an order of language model tasks, and the like, based on the new schedule.

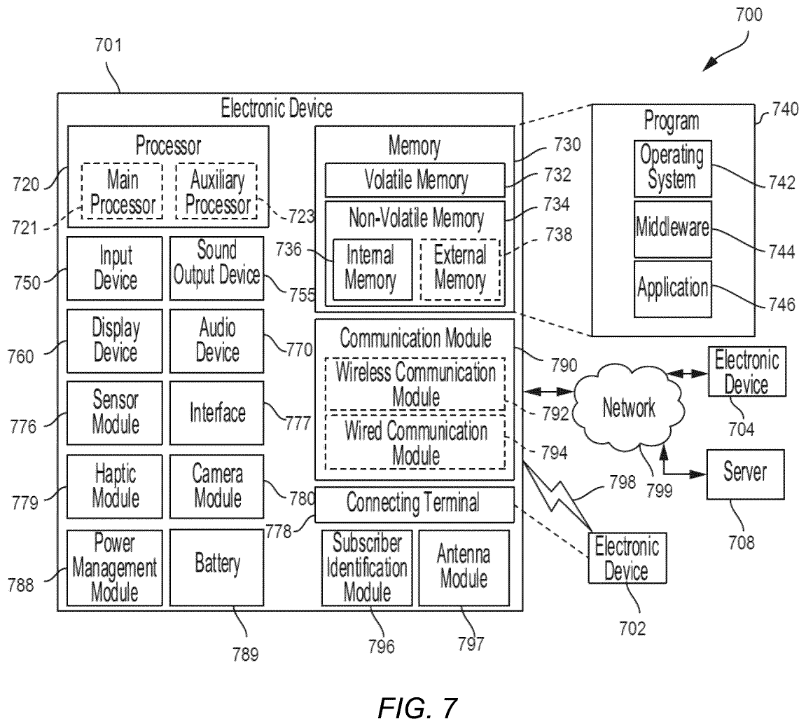

Referring to FIG. 7, an electronic device 701 in a network environment 700 may communicate with an electronic device 702 via a first network 798 (e.g., a short-range wireless communication network), or an electronic device 704 or a server 708 via a second network 799 (e.g., a long-range wireless communication network). The electronic device 701 may communicate with the electronic device 704 via the server 708. The electronic device 701 may include a processor 720, a memory 730, an input device 750, a sound output device 755, a display device 760, an audio module 770, a sensor module 776, an interface 777, a haptic module 779, a camera module 780, a power management module 788, a battery 789, a communication module 790, a subscriber identification module (SIM) card 796, or an antenna module 797. In one embodiment, at least one (e.g., the display device 760 or the camera module 780) of the components may be omitted from the electronic device 701, or one or more other components may be added to the electronic device 701. Some of the components may be implemented as a single integrated circuit (IC). For example, the sensor module 776 (e.g., a fingerprint sensor, an iris sensor, or an illuminance sensor) may be embedded in the display device 760 (e.g., a display).

The processor 720 may execute software (e.g., a program 740) to control at least one other component (e.g., a hardware or a software component) of the electronic device 701 coupled with the processor 720 and may perform various data processing or computations.

As at least part of the data processing or computations, the processor 720 may load a command or data received from another component (e.g., the sensor module 776 or the communication module 790) in volatile memory 732, process the command or the data stored in the volatile memory 732, and store resulting data in non-volatile memory 734. The processor 720 may include a main processor 721 (e.g., a central processing unit (CPU) or an application processor (AP)), and an auxiliary processor 723 (e.g., a graphics processing unit (GPU), an image signal processor (ISP), a sensor hub processor, or a communication processor (CP)) that is operable independently from, or in conjunction with, the main processor 721. Additionally or alternatively, the auxiliary processor 723 may be adapted to consume less power than the main processor 721, or execute a particular function. The auxiliary processor 723 may be implemented as being separate from, or a part of, the main processor 721.

The auxiliary processor 723 may control at least some of the functions or states related to at least one component (e.g., the display device 760, the sensor module 776, or the communication module 790) among the components of the electronic device 701, instead of the main processor 721 while the main processor 721 is in an inactive (e.g., sleep) state, or together with the main processor 721 while the main processor 721 is in an active state (e.g., executing an application). The auxiliary processor 723 (e.g., an image signal processor or a communication processor) may be implemented as part of another component (e.g., the camera module 780 or the communication module 790) functionally related to the auxiliary processor 723.

The memory 730 may store various data used by at least one component (e.g., the processor 720 or the sensor module 776) of the electronic device 701. The various data may include, for example, software (e.g., the program 740) and input data or output data for a command related thereto. The memory 730 may include the volatile memory 732 or the non-volatile memory 734. Non-volatile memory 734 may include internal memory 736 and/or external memory 738.

The program 740 may be stored in the memory 730 as software, and may include, for example, an operating system (OS) 742, middleware 744, or an application 746.

The input device 750 may receive a command or data to be used by another component (e.g., the processor 720) of the electronic device 701, from the outside (e.g., a user) of the electronic device 701. The input device 750 may include, for example, a microphone, a mouse, or a keyboard.

The sound output device 755 may output sound signals to the outside of the electronic device 701. The sound output device 755 may include, for example, a speaker or a receiver. The speaker may be used for general purposes, such as playing multimedia or recording, and the receiver may be used for receiving an incoming call. The receiver may be implemented as being separate from, or a part of, the speaker.

The display device 760 may visually provide information to the outside (e.g., a user) of the electronic device 701. The display device 760 may include, for example, a display, a hologram device, or a projector and control circuitry to control a corresponding one of the display, hologram device, and projector. The display device 760 may include touch circuitry adapted to detect a touch, or sensor circuitry (e.g., a pressure sensor) adapted to measure the intensity of force incurred by the touch.

The audio module 770 may convert a sound into an electrical signal and vice versa. The audio module 770 may obtain the sound via the input device 750 or output the sound via the sound output device 755 or a headphone of an external electronic device 702 directly (e.g., wired) or wirelessly coupled with the electronic device 701.

The sensor module 776 may detect an operational state (e.g., power or temperature) of the electronic device 701 or an environmental state (e.g., a state of a user) external to the electronic device 701, and then generate an electrical signal or data value corresponding to the detected state. The sensor module 776 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 777 may support one or more specified protocols to be used for the electronic device 701 to be coupled with the external electronic device 702 directly (e.g., wired) or wirelessly. The interface 777 may include, for example, a high-definition multimedia interface (HDMI), a universal serial bus (USB) interface, a secure digital (SD) card interface, or an audio interface.

A connecting terminal 778 may include a connector via which the electronic device 701 may be physically connected with the external electronic device 702. The connecting terminal 778 may include, for example, an HDMI connector, a USB connector, an SD card connector, or an audio connector (e.g., a headphone connector).

The haptic module 779 may convert an electrical signal into a mechanical stimulus (e.g., a vibration or a movement) or an electrical stimulus which may be recognized by a user via tactile sensation or kinesthetic sensation. The haptic module 779 may include, for example, a motor, a piezoelectric element, or an electrical stimulator.

The camera module 780 may capture a still image or moving images. The camera module 780 may include one or more lenses, image sensors, image signal processors, or flashes. The power management module 788 may manage power supplied to the electronic device 701. The power management module 788 may be implemented as at least part of, for example, a power management integrated circuit (PMIC).

The battery 789 may supply power to at least one component of the electronic device 701. The battery 789 may include, for example, a primary cell which is not rechargeable, a secondary cell which is rechargeable, or a fuel cell.

The communication module 790 may support establishing a direct (e.g., wired) communication channel or a wireless communication channel between the electronic device 701 and the external electronic device (e.g., the electronic device 702, the electronic device 704, or the server 708) and performing communication via the established communication channel. The communication module 790 may include one or more communication processors that are operable independently from the processor 720 (e.g., the AP) and supports a direct (e.g., wired) communication or a wireless communication. The communication module 790 may include a wireless communication module 792 (e.g., a cellular communication module, a short-range wireless communication module, or a global navigation satellite system (GNSS) communication module) or a wired communication module 794 (e.g., a local area network (LAN) communication module or a power line communication (PLC) module). A corresponding one of these communication modules may communicate with the external electronic device via the first network 798 (e.g., a short-range communication network, such as BLUETOOTH™, wireless-fidelity (Wi-Fi) direct, or a standard of the Infrared Data Association (IrDA)) or the second network 799 (e.g., a long-range communication network, such as a cellular network, the Internet, or a computer network (e.g., LAN or wide area network (WAN)). These various types of communication modules may be implemented as a single component (e.g., a single IC), or may be implemented as multiple components (e.g., multiple ICs) that are separate from each other. The wireless communication module 792 may identify and authenticate the electronic device 701 in a communication network, such as the first network 798 or the second network 799, using subscriber information (e.g., international mobile subscriber identity (IMSI)) stored in the subscriber identification module 796.

The antenna module 797 may transmit or receive a signal or power to or from the outside (e.g., the external electronic device) of the electronic device 701. The antenna module 797 may include one or more antennas, and, therefrom, at least one antenna appropriate for a communication scheme used in the communication network, such as the first network 798 or the second network 799, may be selected, for example, by the communication module 790 (e.g., the wireless communication module 792). The signal or the power may then be transmitted or received between the communication module 790 and the external electronic device via the selected at least one antenna.

Commands or data may be transmitted or received between the electronic device 701 and the external electronic device 704 via the server 708 coupled with the second network 799. Each of the electronic devices 702 and 704 may be a device of a same type as, or a different type, from the electronic device 701. All or some of operations to be executed at the electronic device 701 may be executed at one or more of the external electronic devices 702, 704, or 708. For example, if the electronic device 701 should perform a function or a service automatically, or in response to a request from a user or another device, the electronic device 701, instead of, or in addition to, executing the function or the service, may request the one or more external electronic devices to perform at least part of the function or the service. The one or more external electronic devices receiving the request may perform the at least part of the function or the service requested, or an additional function or an additional service related to the request and transfer an outcome of the performing to the electronic device 701. The electronic device 701 may provide the outcome, with or without further processing of the outcome, as at least part of a reply to the request. To that end, a cloud computing, distributed computing, or client-server computing technology may be used, for example.

Embodiments of the subject matter and the operations described in this specification may be implemented in digital electronic circuitry, or in computer software, firmware, or hardware, including the structures disclosed in this specification and their structural equivalents, or in combinations of one or more of them. Embodiments of the subject matter described in this specification may be implemented as one or more computer programs, i.e., one or more modules of computer-program instructions, encoded on computer-storage medium for execution by, or to control the operation of data-processing apparatus. Alternatively or additionally, the program instructions can be encoded on an artificially-generated propagated signal, e.g., a machine-generated electrical, optical, or electromagnetic signal, which is generated to encode information for transmission to suitable receiver apparatus for execution by a data processing apparatus. A computer-storage medium can be, or be included in, a computer-readable storage device, a computer-readable storage substrate, a random or serial-access memory array or device, or a combination thereof. Moreover, while a computer-storage medium is not a propagated signal, a computer-storage medium may be a source or destination of computer-program instructions encoded in an artificially-generated propagated signal. The computer-storage medium can also be, or be included in, one or more separate physical components or media (e.g., multiple CDs, disks, or other storage devices). Additionally, the operations described in this specification may be implemented as operations performed by a data-processing apparatus on data stored on one or more computer-readable storage devices or received from other sources.

While this specification may contain many specific implementation details, the implementation details should not be construed as limitations on the scope of any claimed subject matter, but rather be construed as descriptions of features specific to particular embodiments. Certain features that are described in this specification in the context of separate embodiments may also be implemented in combination in a single embodiment. Conversely, various features that are described in the context of a single embodiment may also be implemented in multiple embodiments separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described herein. Other embodiments are within the scope of the following claims. In some cases, the actions set forth in the claims may be performed in a different order and still achieve desirable results. Additionally, the processes depicted in the accompanying figures do not necessarily require the particular order shown, or sequential order, to achieve desirable results. In certain implementations, multitasking and parallel processing may be advantageous.

As will be recognized by those skilled in the art, the innovative concepts described herein may be modified and varied over a wide range of applications. Accordingly, the scope of claimed subject matter should not be limited to any of the specific exemplary teachings discussed above, but is instead defined by the following claims and their equivalents.

What is claimed is:

1. A manufacturing system comprising:
a processor; and
a memory storing instructions executed by the processor to cause the processor to:
identify one or more converging agents from a first group of agents;
in response to the identification of the one or more converging agents, perform training of one or more non-converging agents of the first group of agents using historic data to form a second group of agents;
identify one or more converging agents from the second group of agents;
in response to the identification of the one or more converging agents from the second group of agents, update policy of the one or more non-converging agents of the second group of agents based on historic data collected by heuristic rule-based policy to form a third group of agents; and
deploy, a policy based on the first group of agents, the second group of agents, and the third group of agents.

2. The system of claim 1, wherein the training of the one or more non-converging agents of the first group of agents comprises performing reinforcement learning training.

3. The system of claim 2, wherein the training is performed offline and the historic data is collected from a multi-agent environment.

4. The system of claim 3, wherein the training comprises determining a least-squared temporal difference.

5. The system of claim 1, wherein the instructions further cause the processor to freeze neural network weights of the identified one or more converging agents from the first group of agents and the second group of agents.

6. The system of claim 1, wherein the heuristic rule-based policy corresponds to a known reward function.

7. The system of claim 6, wherein the updating the policy of the one or more non-converging agents of the second group of agents comprises setting a least-squared temporal difference between the policy and the heuristic rule.

8. The system of claim 1, wherein the instructions further cause the processor to:
identify one or more converging agents from the third group of agents;
in response to the identification of the one or more converging agents from the third group of agents, assigning a heuristic policy to one or more non-converging agents from the third group of agents; and
combine the converging agents from the first group of agents, the second group of agents, and the third group of agents, with the assigned heuristic policy.

9. A method comprising:
identifying, by a processor, one or more converging agents from a first group of agents;
in response to the identification of the one or more converging agents, performing, by the processor, training of one or more non-converging agents of the first group of agents using historic data to form a second group of agents;
identifying, by the processor, one or more converging agents from the second group of agents;
in response to the identification of the one or more converging agents from the second group of agents, updating, by the processor, policy of the one or more non-converging agents of the second group of agents based on historic data collected by heuristic rule-based policy to form a third group of agents; and
deploying, by the processor, a policy based on the first group of agents, the second group of agents, and the third group of agents.

10. The method of claim 9, wherein the training of the one or more non-converging agents of the first group of agents comprises performing reinforcement learning training.

11. The method of claim 10, wherein the training is performed offline and the historic data is collected from a multi-agent environment.

12. The method of claim 11, wherein the training comprises determining a least-squared temporal difference.

13. The method of claim 9, further comprising freezing neural network weights of the identified one or more converging agents from the first group of agents and the second group of agents.

14. The method of claim 9, wherein the heuristic rule-based policy corresponds to a known reward function.

15. The method of claim 14, wherein the updating the policy of the one or more non-converging agents of the second group of agents comprises setting a least-squared temporal difference between the policy and the heuristic rule.

16. The method of claim 9, further comprises:
Identifying, by the processor, one or more converging agents from the third group of agents;
in response to the identification of the one or more converging agents from the third group of agents, assigning, by the processor, a heuristic policy to one or more non-converging agents from the third group of agents; and
combining, by the processor, the converging agents from the first group of agents, the second group of agents, and the third group of agents, with the assigned heuristic policy.

17. A computer-readable medium storing instructions that, when executed by one or more processors, cause the one or more processors to perform a method comprising:
identifying, by a processor, one or more converging agents from a first group of agents;
in response to the identification of the one or more converging agents, performing, by a processor, training of one or more non-converging agents of the first group of agents using historic data to form a second group of agents;
identifying, by a processor, one or more converging agents from the second group of agents;
in response to the identification of the one or more converging agents from the second group of agents, updating, by a processor, policy of the one or more non-converging agents of the second group of agents based on historic data collected by heuristic rule-based policy to form a third group of agents;
deploying a policy based on the first group of agents, the second group of agents, and the third group of agents.

18. The computer-readable medium of claim 17,
wherein the training of the one or more non-converging agents of the first group of agents comprises performing reinforcement learning training, and
wherein the training is performed offline and the historic data is collected from a multi-agent environment.

19. The computer-readable medium of claim 17, wherein the one or more processors performs a method comprising freezing neural network weights of the identified one or more converging agents from the first group of agents and the second group of agents.

20. The computer-readable medium of claim 17, wherein the one or more processors performs a method comprising:
identifying one or more converging agents from the third group of agents;
in response to the identification of the one or more converging agents from the third group of agents, assigning a heuristic policy to one or more non-converging agents from the third group of agents; and
combining, by the processor, the converging agents from the first group of agents, the second group of agents, and the third group of agents, with the assigned heuristic policy.
